(19) United States
(12) Patent Application Publication
(10) Pub. No.: US 2008/0275726 A1
(43) Pub. Date: Nov. 6, 2008

(54) SYSTEM AND METHOD FOR METABOLIC PATIENT MANAGEMENT AND TREATMENT

(76) Inventor: Steven Yannicelli, Valencia, CA (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/874,195

(22) Filed: Oct. 17, 2007

Related U.S. Application Data
(60) Provisional application No. 60/915,674, filed on May 2, 2007.

(51) Int. Cl. G06Q 50/00

(52) U.S. Cl. 705/2

(57) ABSTRACT

A patient management system for assisting in the treatment of individuals having metabolic disorders is provided. More specifically, the present invention provides a system and method for dynamically calculating multiple parameters and conditions based on various attributes (e.g., disorder, age, weight and gender) to establish required nutritional goals specific to a particular metabolic patient. Thereafter, a unique exchange based mechanism is employed to simplify food breakdown and corresponding nutritional values to construct an accurate dietary prescription plan for meeting those required nutritional goals.

### CROSS-REFERENCE TO RELATED APPLICATIONS

This application claims the benefit or U.S. Provisional Patent Application No. 60/915,674, filed May 2, 2007, which is hereby incorporated by reference herein in its entirety.

### BACKGROUND OF THE INVENTION

1. Field of the Invention

The present invention relates generally to the field of patient management systems and methods. More particularly, the present invention is directed to a system and, method for managing and treating patients with metabolic disorders.

2. Description of the Prior Art

A metabolic disorder is a condition where the body has an inability to metabolize consumed substances into energy and other metabolic byproducts. Most metabolic disorders are genetic in nature, although they can also be developed due to poor dieting, the presence of toxins in the body or by way of an infection.

Generally, metabolic disorders are caused by genetic defects relating to enzyme malfunctions in the body. The generation of specific enzymes is essential to the breakdown of food into its simpler nutritional constituents and energy, as well as for handling the transfer of those constituents and energy into products for use by the human body to support normal biochemical functions. When the body lacks or is simply unable to produce enough biochemical activity of these essential enzymes, various compounds meant to be broken down by these enzymes may build up to toxic levels within the body. Moreover, the biochemical products produced from these enzymes are deficient. Therefore, an individual's body may follow a typical balanced diet, but still lack necessary nutritional elements due to its inability to properly breakdown and utilize nutrients that have been consumed.

Since symptoms associated with a metabolic disorder can be vague and difficult to diagnose, determining the most beneficial treatment for the disorder can be extremely complicated. The current availability of treatments for metabolic disorders vary, depending on the type of disorder and the severity of the condition. Various drugs and therapy can be prescribed, but typically an individual having a metabolic disorder is best treated when an alteration in diet is prescribed. Treatment through alterations in diet has been shown to be very effective in stabilizing metabolic disorders, allowing individuals with such disorders to continue living a healthy and functional life.

Although treatment through alterations in diet have proven to be effective in stabilizing metabolic disorders, the time and process entailed for constructing these special diets are cumbersome and often prone to inaccuracies. Dieticians and clinicians have traditionally been limited to referring to various metabolic protocols and an overabundance of corresponding dietary products, calculating diet plans as best as they can base on their findings. Alternatively, some dieticians and clinicians are forced to utilize predefined diet plans for known metabolic disorders, but these plans are not necessarily the most beneficial for every individual having the same metabolic disorder since various attributes pertaining to an individual can have a significant role in deriving the appropriate alteration in diet. Although it is well known that incorporation of a plurality of physiological parameters and an individual's other attributes best serve in determining the most beneficial dietary alteration suitable for an individual, the ability to consider the various attributes, along with being well informed of all existing protocols and the availability of dietary products, is understandably difficult to balance on a individual-by-individual basis.

Accordingly, it is desirable to provide an improved method for treating individuals having a metabolic disorder, along with a complementary system configured to assist in monitoring and regulating the foregoing improved treatment method in accordance with each individual's needs.

### SUMMARY THE INVENTION

It is an object of the present invention to provide an improved means for calculating dietary prescription plans, thereby minimizing time consuming efforts associated with antiquated methods and increasing the accuracy and efficacy of treatments for metabolic patients.

It is another object of the present invention to provide a means for enabling customization of dietary options, thereby providing greater variety and flexibility in treatments for metabolic patients.

It is yet another object of the present invention to provide a means for quick and easy generation of treatment history and documents, thereby providing an efficient means for monitoring the progress and need for adjustments of treatments for metabolic patients.

In light of the foregoing, these and other objectives are accomplished in accordance with the principles of the present invention, wherein the novelty of the present invention will become apparent from the following detailed description and appended claims, and wherein a system and method for the management and treatment of metabolic patients is provided.

A patient management system configured to centralize and provide practitioners (i.e., dietitians and clinicians) with a plurality of patient management options is deployed. The patient management system of the present invention provides, but is certainly not limited to, a means for maintaining and customizing a database of a practitioner's metabolic patients, automated means for calculating nutritional goals and determining deficiencies in those goals in order to create a corresponding dietary prescription plan, dietary product management tools, various report generation schemes, patient scheduling options and administrative features for regulating access and management of metabolic patient profiles. Additionally, the patient management system may be configured to provide ease of access to the most relevant information pertaining to metabolic disorders and the corresponding variety of treatment products available for assisting in the treatment of those disorders, thereby enabling a robust and full-service environment for the management and treatment of metabolic patients.

In a preferred embodiment of the present invention, a secure, Health Information Portability and Accountability Act (HIPAA) compliant, web-based patient management system is provided, employing electronic protocols that are configured to derive patient-specific dietary prescription plans for treatment of metabolic disorders. Creation of these dietary prescription plans are initiated by automated dynamic calculations that take into consideration multiple parameters and conditions based on predefined attributes associated with a particular metabolic patient. Such attributes may include, for example, identification of the metabolic disorder type, age, weight, gender, phenylalanine (PHE) levels, tyrosine (TYR) levels, protein levels, energy levels and any other applicable attribute determined to be suitable for accurate nutrition management of a metabolic disorder.

Upon completion of the foregoing calculations, optimal nutritional goals are established for the particular metabolic patient and either an exchange or non-exchange based mechanism may be employed to simplify essential food breakdowns and their corresponding nutritional values. Both exchange and non-exchange methods help to create and balance a dietary prescription plan to meet the pre-calculated established goals. Additionally, a plurality of medical foods and supplements are provided to assist the balancing process initiated by the exchange based mechanism. Therefore, a versatile patient management system is provided, having the ability to accommodate various attributes and seamlessly calculate nutritional goals, and thereby create accurate and stable dietary prescription plans for metabolic patients to follow.

### BRIEF DESCRIPTION OF THE DRAWINGS

The above and other objects and advantages of the present invention will become apparent upon consideration of the following detailed description, taken in conjunction with the accompanying drawings, in which like reference characters refer to like parts throughout, and in which:

FIG. 1 illustrates a block diagram of an exemplary communication network for implementing the patient management system in accordance with preferred embodiments of the present invention.

FIG. 2 is an illustrative main display screen for accessing multiple patient management resources in accordance with an embodiment of the present invention.

FIGS. 3A-3C are illustrative display screens for management of metabolic patient records in accordance with an embodiment of the present invention.

FIGS. 4A-4H are illustrative display screens for generating a dietary prescription plan in accordance with an embodiment of the present invention.

FIG. 5 is an illustrative display screen for creating reports in accordance with an embodiment of the present invention.

FIGS. 6A-6C are process flowcharts for illustrating steps employed in creating a dietary prescription plan in accordance with an embodiment of the present invention.

FIGS. 7A-7C are process flowcharts for illustrating steps employed in filling the dietary prescription in accordance with an embodiment of the present invention.

### DETAILED DESCRIPTION OF THE PREFERRED EMBODIMENTS

The present invention is directed towards a system and method for managing and treating individuals having metabolic disorders. For purposes of clarity, and not by way of limitation, illustrative views and process flows of the methods employed in the system of the present invention are described with references made to the above-identified figures. Various modifications obvious to one skilled in the art are deemed to be within the spirit and scope of the present invention.

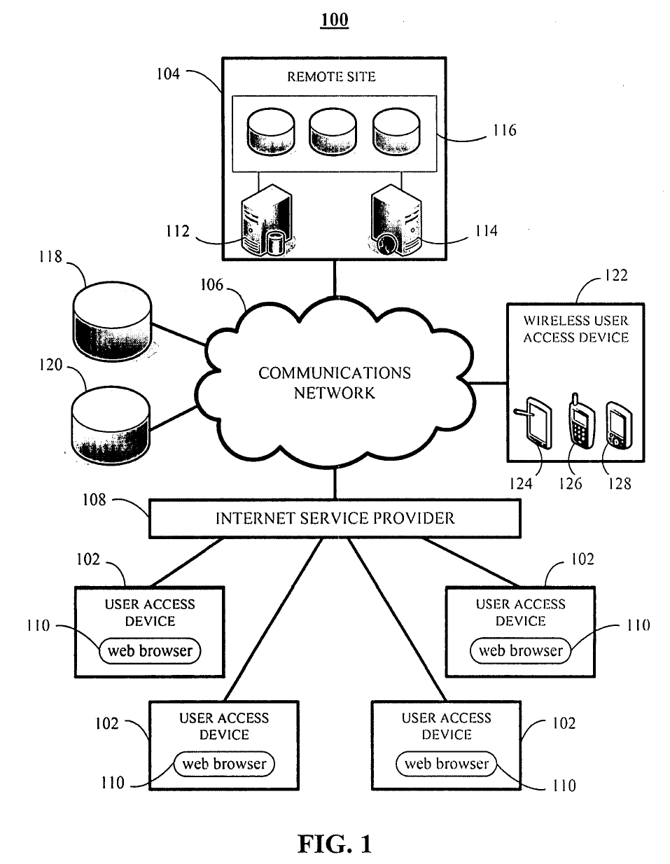

FIG. 1 shows an exemplary communication network 100 for implementing a patient management system in accordance with the present invention. For purposes of clarity, and not by way of limitation, an illustrative client-server based embodiment of the present invention is herein described. Alternative networking components, devices and systems can be envisioned. Communication network 100 is comprised of a plurality of user access devices 102 and a remote site 104 coupled via a communications network 106. In practice, there may be more than one remote site 104, but only one is shown to avoid over-complication of the drawing. Remote site 104 may be any suitable remote site and may include equipment such as, for example, one or more servers, mainframes, personal computers, or any other suitable computer-based equipment. Remote site 104 may include a network of computers that may be interconnected in any suitable way such as, for example, through a local area network, wide area network, telephone network, cable television network, Intranet, Internet, or any other suitable wired or wireless communications network.

The term “computer”, as used herein, is not limited to a distinct piece of computing hardware, but may also be any data processing device such as a desktop computer, a laptop computer, a mainframe computer, a personal digital assistant (PDA) or a combination thereof. Any device configured to process, manage or transmit data, whether implemented with electrical, magnetic, optical, biological components or otherwise, may be suitable for implementing the present invention.

Communications network 106 may be any suitable communications network such as, for example, a local area network, wide area network, telephone network, cable television network, Intranet, Internet, or any other suitable wired or wireless communications network. Some suitable wireless communications networks may be global system for mobile communications (GSM), time-division multiple access (TDMA), code-division multiple access (CDMA), Bluetooth, or any other suitable wireless communication networks. User access devices 102 and remote site 104 may communicate over communications network 106 using any suitable protocol or protocol stack. For example, user access devices 102 and remote site 104 may communicate via a transmission control protocol/Internet protocol (TCP/IP) environment. Any suitable request-response type of protocol and socket-based packet transport stack, or suitable peer-to-peer communications approach may be used as desired.

In one embodiment of the present invention, user access devices 102 may any one of a plurality of devices that may be connected to communications network 106. In Internet-based approaches, as illustrated in FIG. 1 for example, user access devices 102 may be connected to the Internet via an Internet service provider (ISP) 108. User access devices 102 may be any device suitable for communicating with remote site 104 via communications network 106. For example, user access devices 102 may be a personal computer, PDA, a terminal or any other suitable device that provides access to remote site 104 via communications network 106. User access devices 102 may include, for example, an Internet browser application 110 that may be used to access web pages via communications network 106.

User access devices 102 may communicate with ISP 118 or directly with communications network 106 using any suitable communications link. For example, the link may include a telephone dial-up link, digital subscriber lines (DSL), a cable modem link (e.g., a data over cable service interface specification (DOCSIS)), a satellite link, a computer network link (e.g., Ethernet link, T1 line, etc.) or any other suitable communications link or combination of communications links.

Remote site 104 may include one or more servers such as, for example, a database server 112 and a web server 114. Alternatively, servers 112 and 114 may not be segregated at all, but rather all necessary applications and functions of the patient management system may reside on a single server. Servers 112 and 114 may be coupled to various onsite databases 116, or remote databases 118 and 120 via communications network 106, for storing and retrieving data. For example, encrypted patient data may be kept and accessed from the foregoing databases. Alternatively, one or more mirrored servers may be provided as a backup for holding current databases and updated web applications. In other suitable approaches, such as in non-Internet based approaches, remote site 104 may include an application server (not shown) or any other suitable server or combination of servers. The term “server”, as used herein, is not limited to a distinct piece of computing hardware or storage component, but may also be a software application or a combination of hardware and software. For example, one computer may have software that enables the computer to act as both a web server and as a database server.

In some suitable approaches, remote site 104 may provide displays or display definitions to user access devices 102. In the Internet-based approach illustrated in FIG. 1, for example, web server 114 may generate static and dynamic web pages from data supplied by database server 112. A web page may be viewed by a user using Internet browser 110 running on user access device 102.

Remote site 104 may function as the master controller of communication network 100. In addition, users may access communication network 100 via any wired user access device 102 or, alternatively, a wireless user access devices 122 suitably configured to link with communications network 106. Wireless user access device 122 may include, for example, a personal computer or tablet notebook 124, a cellular and/or smart phone 126, PDA 126 or any other device enabled for wireless access of remote site 104 via communications network 106.

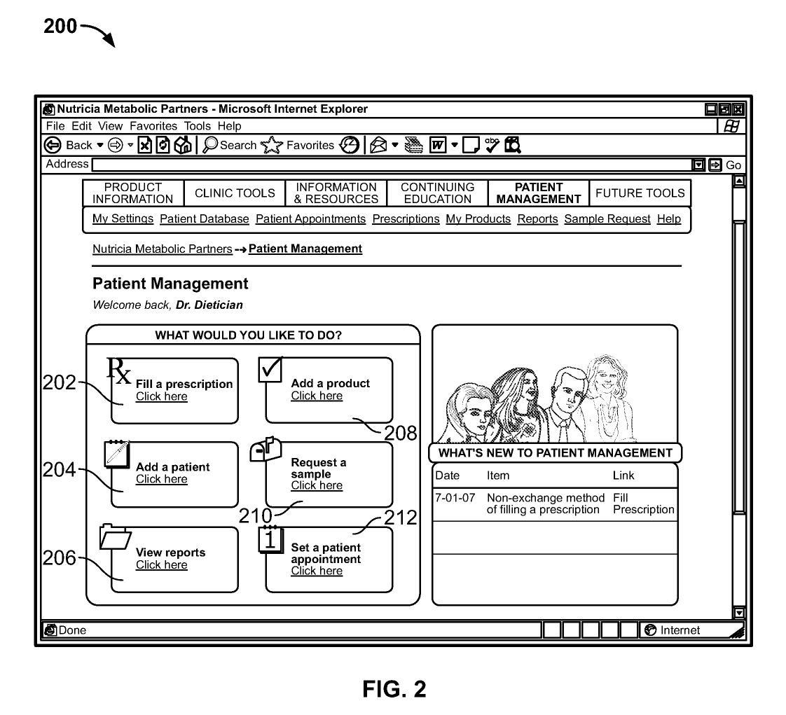

FIGS. 2, 3A-3C, 4A-4H and 5 are illustrative display screens that may be provided to a user practitioner (e.g., dieticians or clinicians) through the patient management system available, for example, via communication network 100. The illustrative displays are shown as web-based display pages that may be generated, for example, by web server 114 and displayed on web browser 110. However, it should be understood that the displays need not be limited to being displayed in a web browser or using an Internet-based or client-server based approach. The displays shown in FIGS. 2, 3A-3C, 4A-4H and 5 are merely provided as a means for describing features of the present invention and, if desired, any other suitable display interface may be used for purposes of providing practitioners with access to the patient management system.

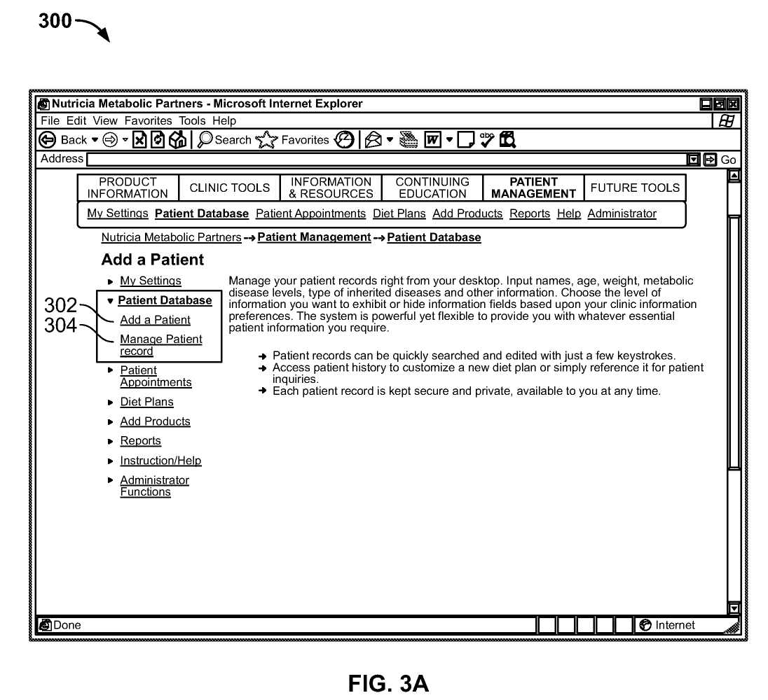

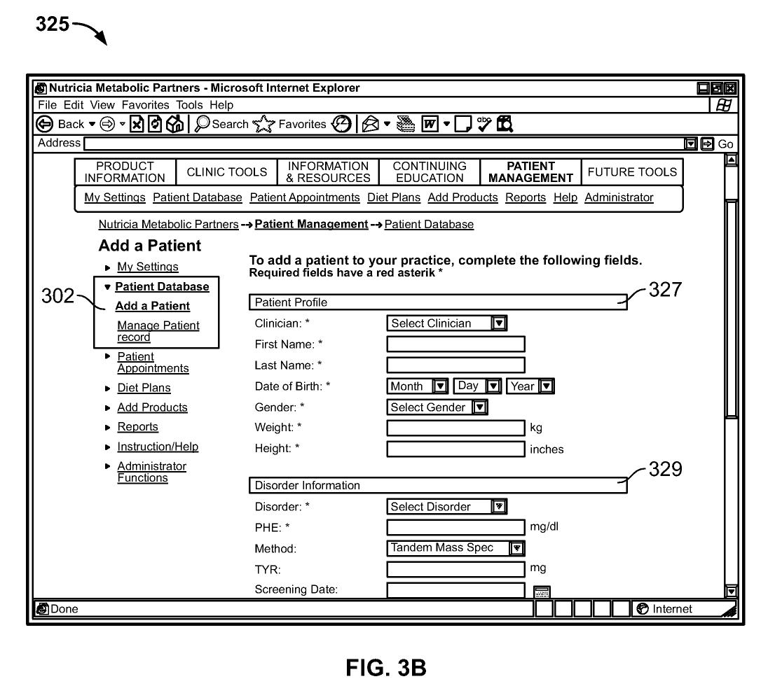

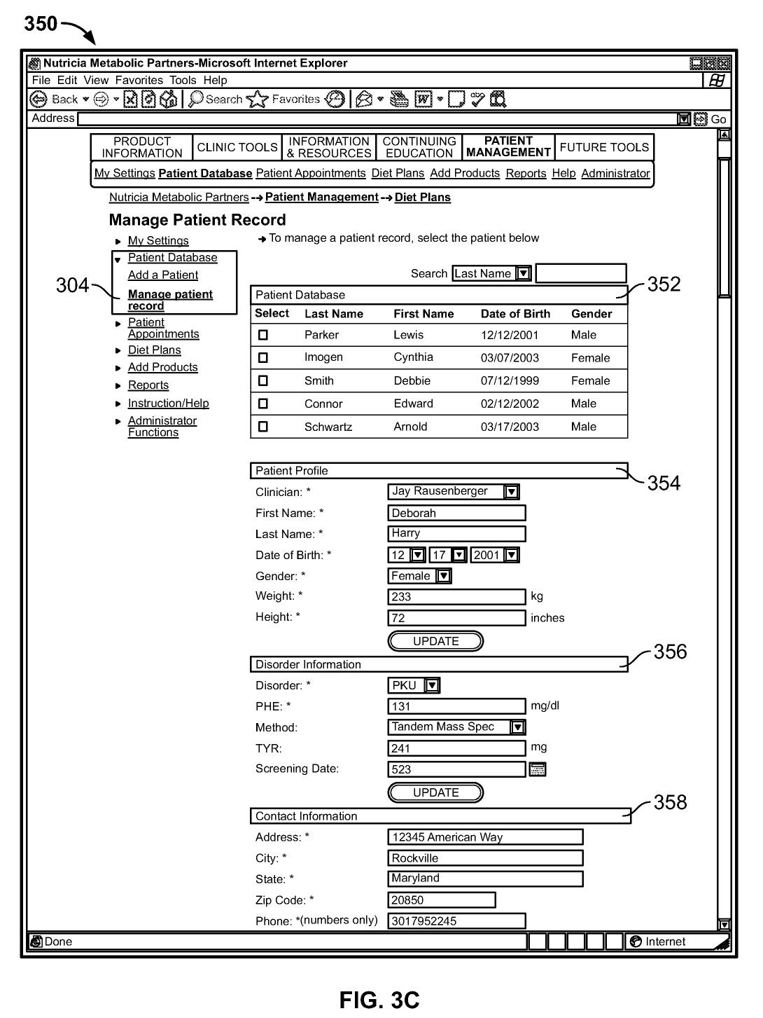

FIG. 2 shows a main display page 200 for enabling user interaction with the patient management system of the present invention. As illustrated, main display 200 may provide practitioners with a plurality of patient management tools such as, for example, a prescription management option 202, a patient database management option 204, a reports management option 206, a products management option 208, a product sample management option 210 and a patient appointment management option 212. If a practitioner selects patient management option 204, for example, then a patient database main display page 300, as illustrated in FIG. 3A, may be presented to the practitioner. Main display page 300 provides practitioners with the ability to add new metabolic patients, via patient management option 302, and to manage existing metabolic patients records, via patient management option 304. A listing of metabolic patient records may be displayed in various, as well as customizable, formats. For example, a particular practitioner may wish to have a listing of their patient records sorted and displayed by name, age, weight, metabolic disorder or any combination thereof.

When practitioners want to add a new patient to their database, patient management option 302 is selected and a new patient information display page 325 may be provided, as illustrated in FIG. 3B. Display page 325 may solicit information to create a patient profile 327 and a corresponding disorder profile 329. Patient profile 327 may provide fields for entering patient information, such as identification of a treating clinician, a patient's first and last names, the patient's date of birth, the patient's gender, the patient's weight and the patient's height. Disorder profile 329 may provide fields for entering information pertaining to the patient's metabolic disorder, such as identification of the disorder, the patient's blood phenylalanine (PHE) measurement in mg/dL, the patient's blood tyrosine (TYR) measurement in mg/dL and the last screening date corresponding with each of those measurements. The foregoing fields are merely illustrative of the information that may be solicited when patient management option 302 is selected, and it should be noted that additional information applicable to proper evaluation of a patient's metabolic disorder in conjunction with the dietary management tools enabled by the present invention may be solicited as well.

Previously created and stored patient profiles may be easily accessed through selection of patient management option 304. Upon selection of option 304, a database listing of existing patients may be generated on display page 350, as illustrated in FIG. 3C. Display page 350 provides practitioners with an ability to select any pre-existing patient from the listing of patients provided in a patient database 352, as well as an ability to review and update information related to a selected patient using the fields and update options provided under a patient profile 354, a disorder profile 356 and a contact information profile 358.

Patient database 352 may be searched using a plurality of criteria. For example, patients listed under patient database 352 may be sorted and displayed by last name, first name, disorder type, date of birth or any other useful identifying criteria. When a patient listed under patient database 352 is selected, that patient's profile, disorder and contact information is displayed, respectively, in the fields provided under patient profile 354, disorder profile 356 and contact information profile 358. The fields provided under patient profile 354 and disorder profile 356 are constructed similarly to the previously described fields provided under patient profile 327 and disorder profile 329, except that the fields appearing under patient profile 354 and disorder profile 356 are populated with information entered for that particular patient on an earlier occasion.

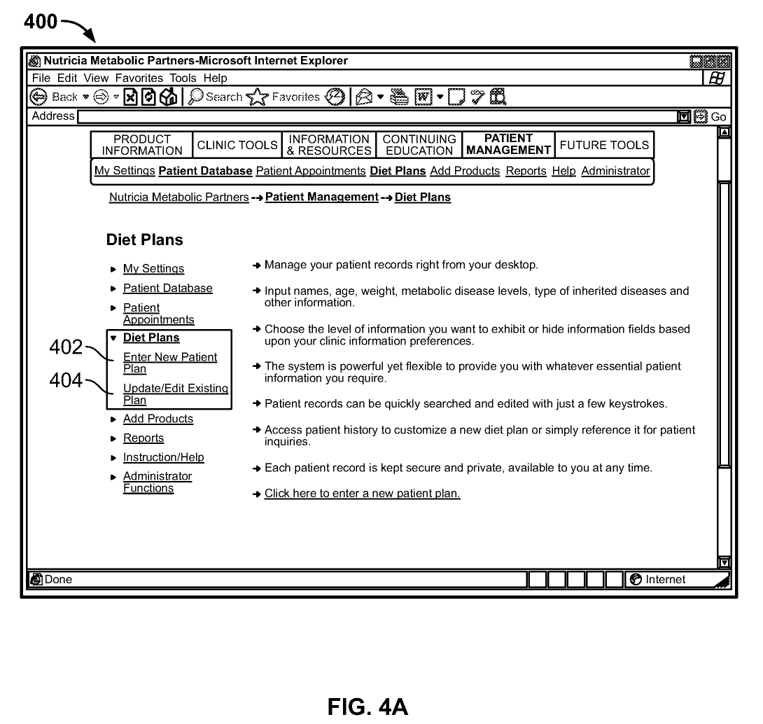

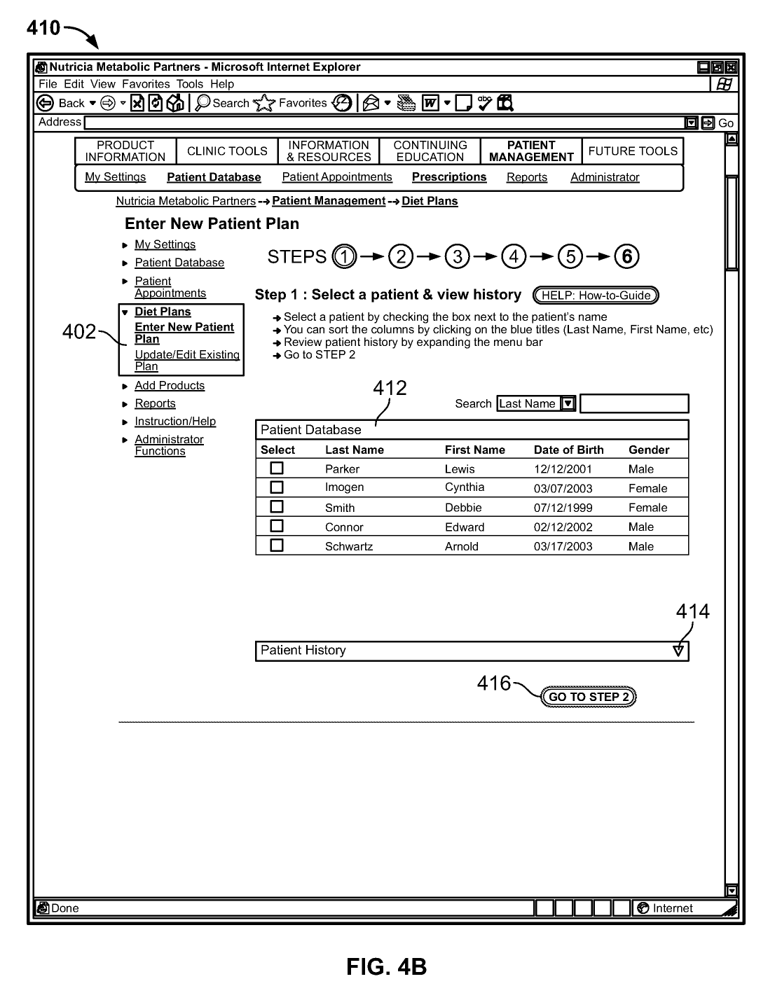

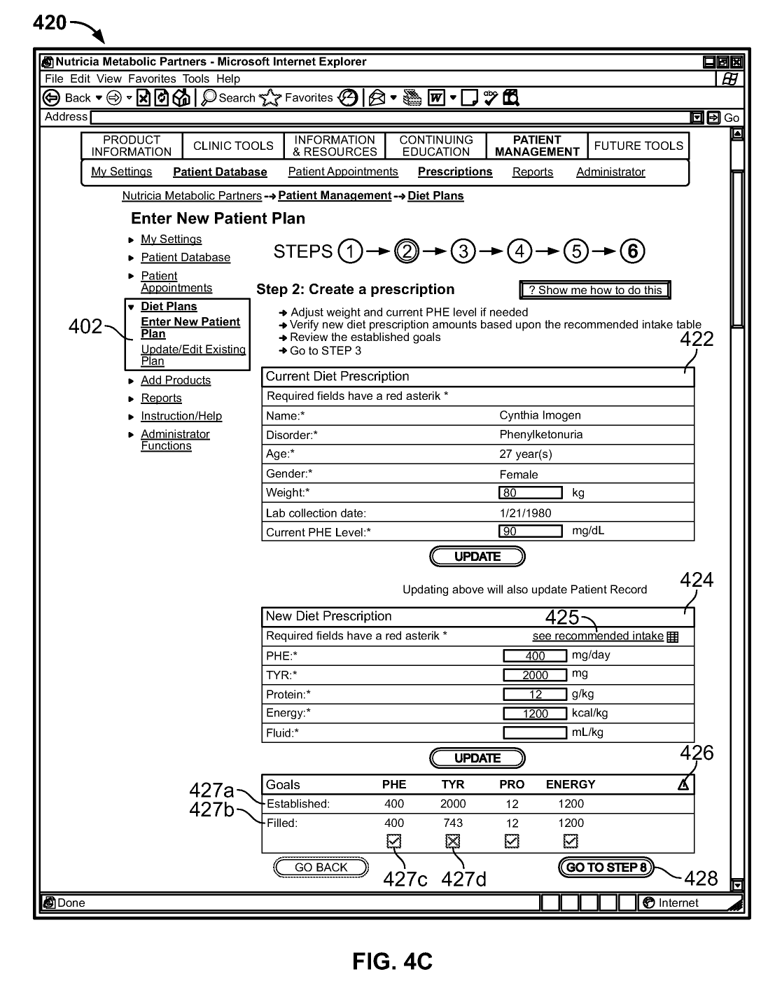

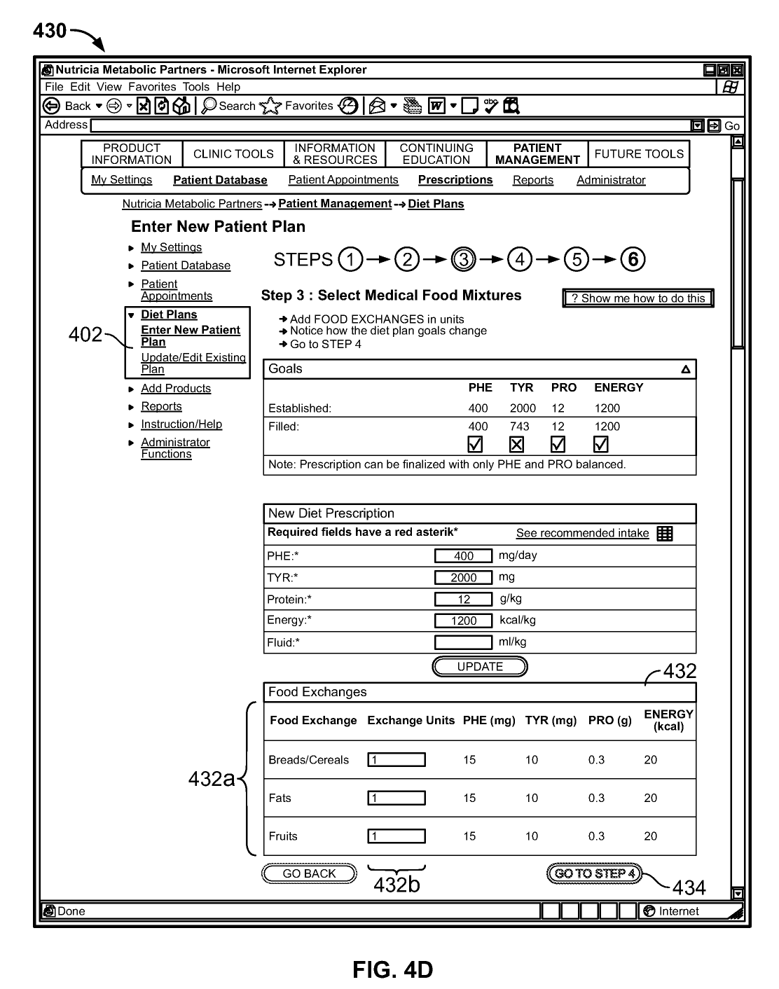

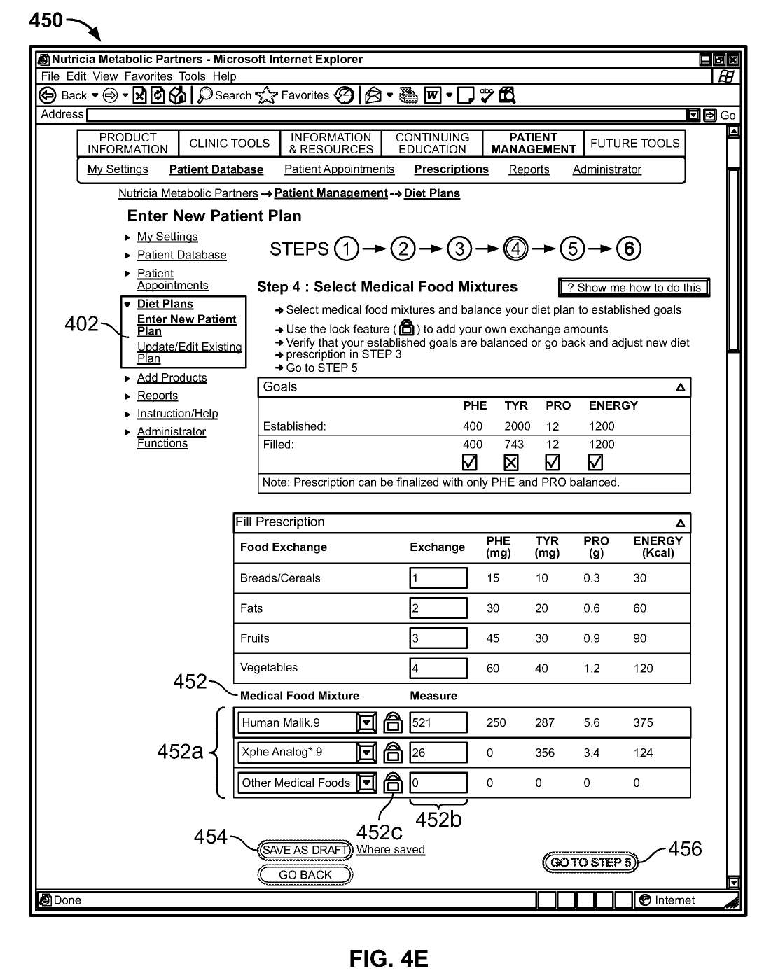

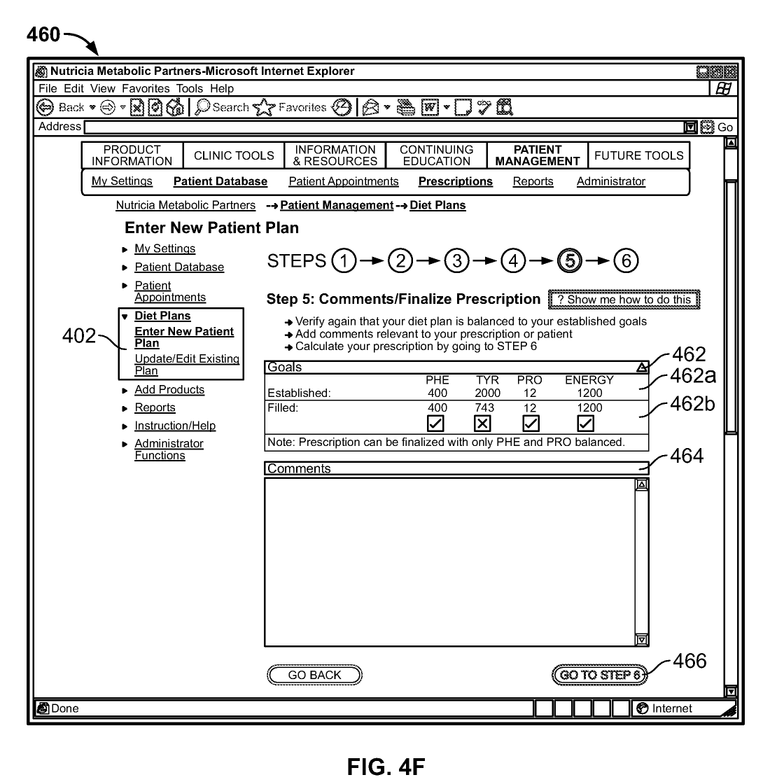

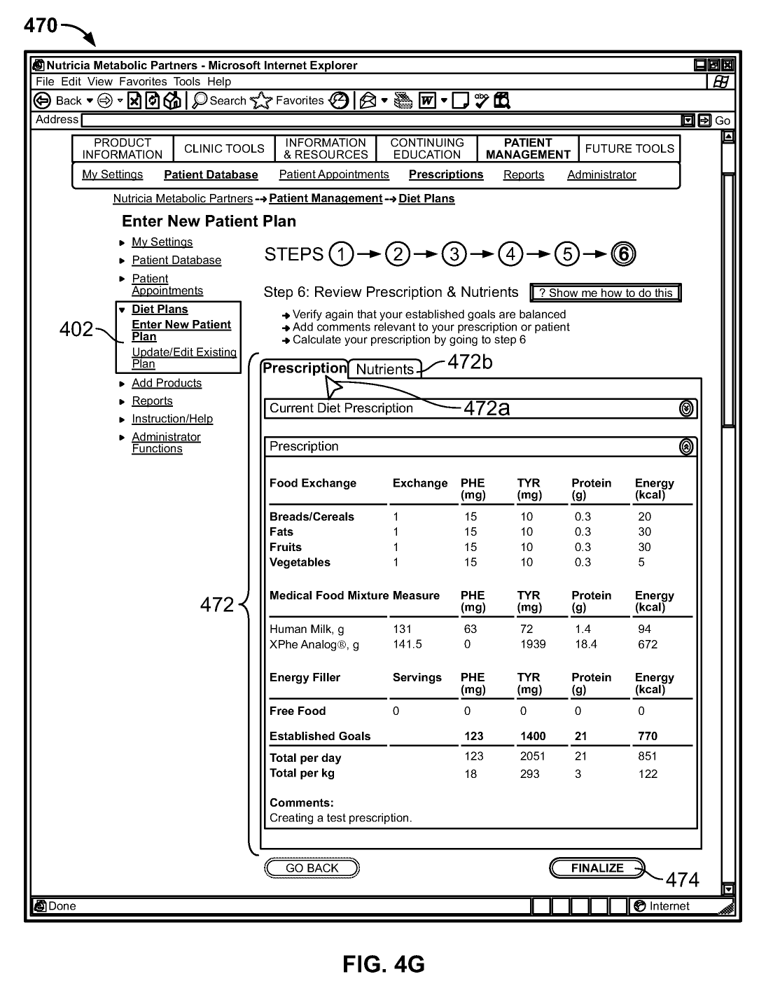

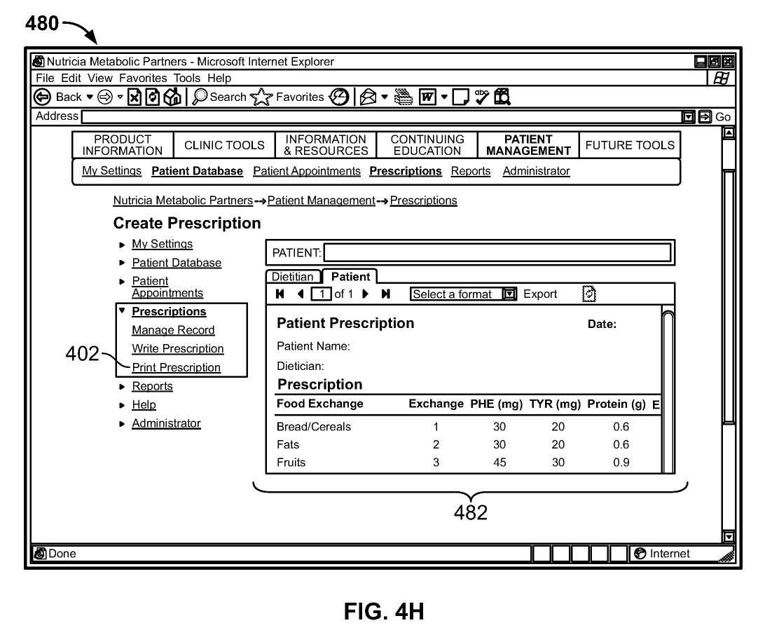

FIG. 4A illustrates a diet plan main display page 400, which may be displayed to practitioners when prescription management option 202 (FIG. 2) is selected. Main display page 400 provides practitioners with the ability to create new dietary prescription plans, via patient management option 402, and to update existing dietary prescription plans, via patient management option 404, that are suitable for their metabolic patients.

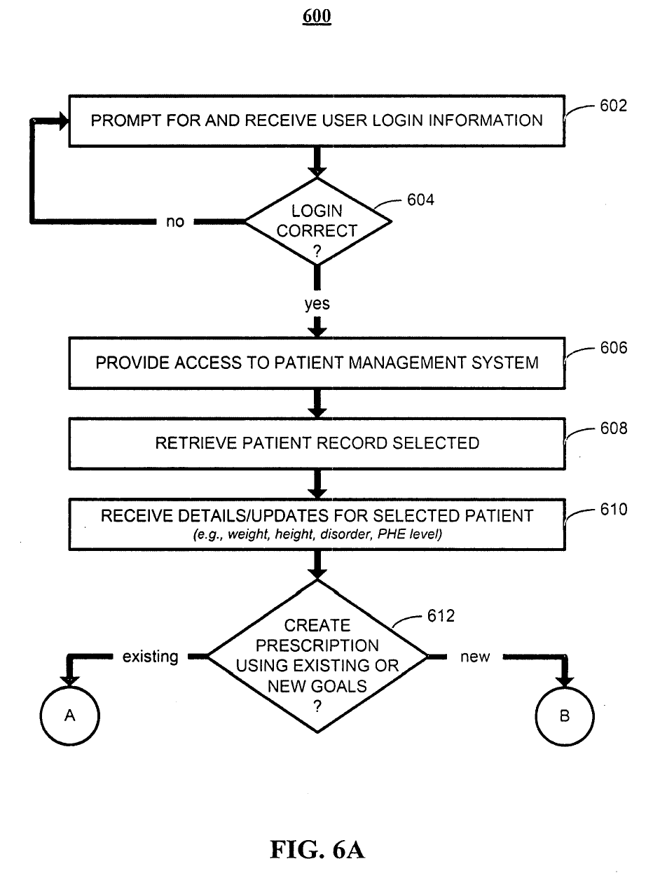

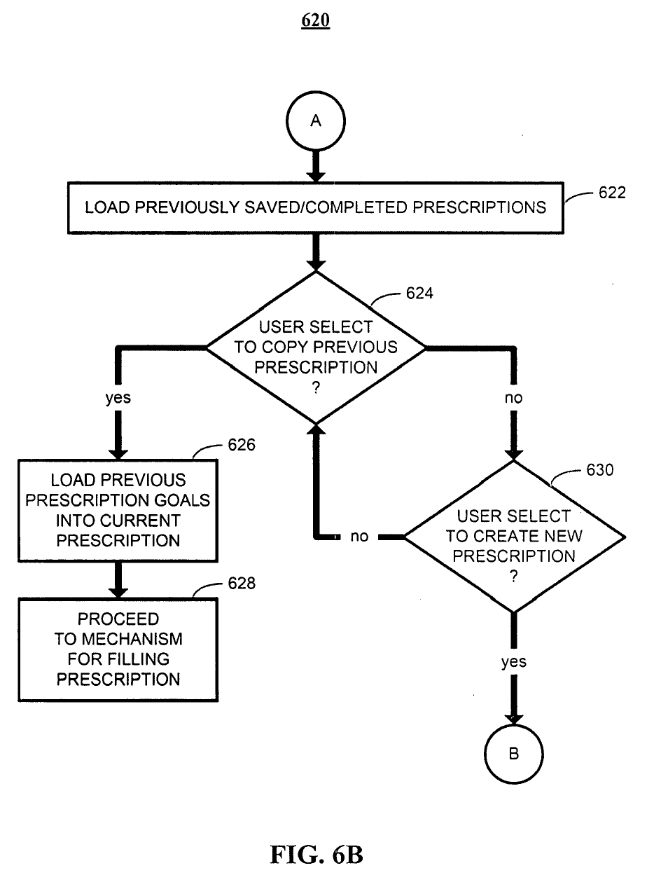

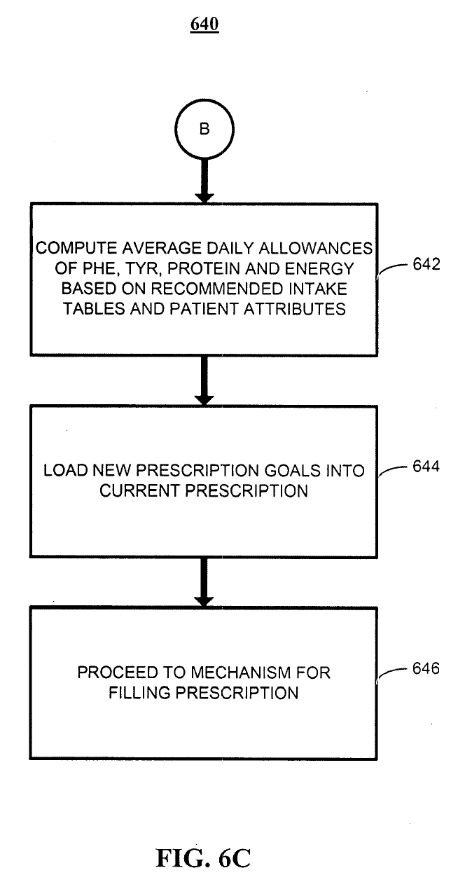

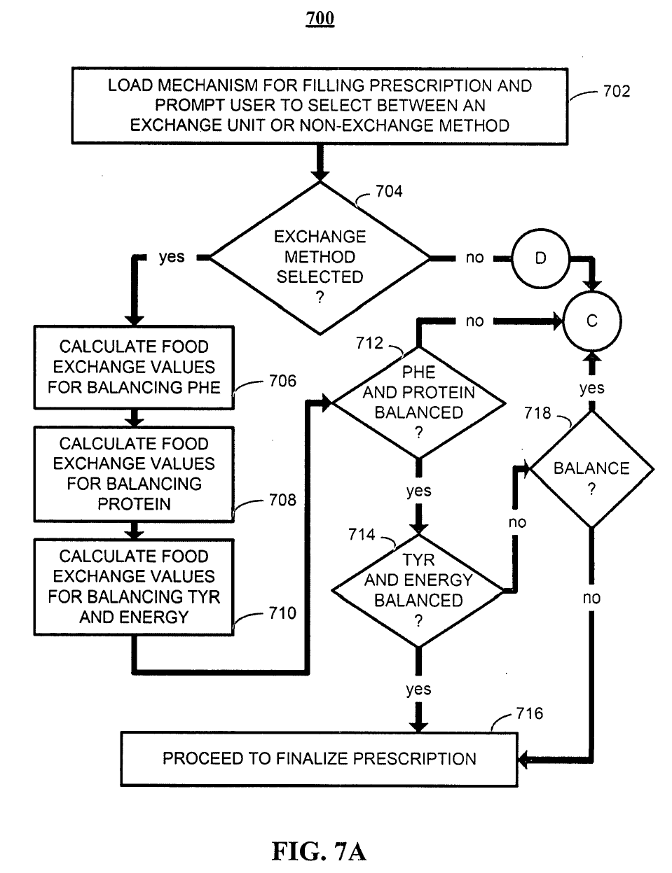

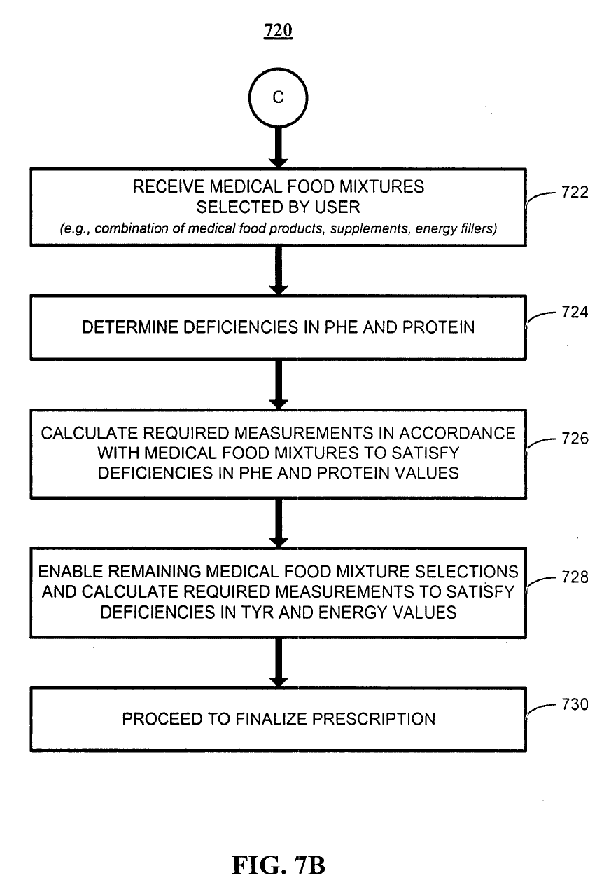

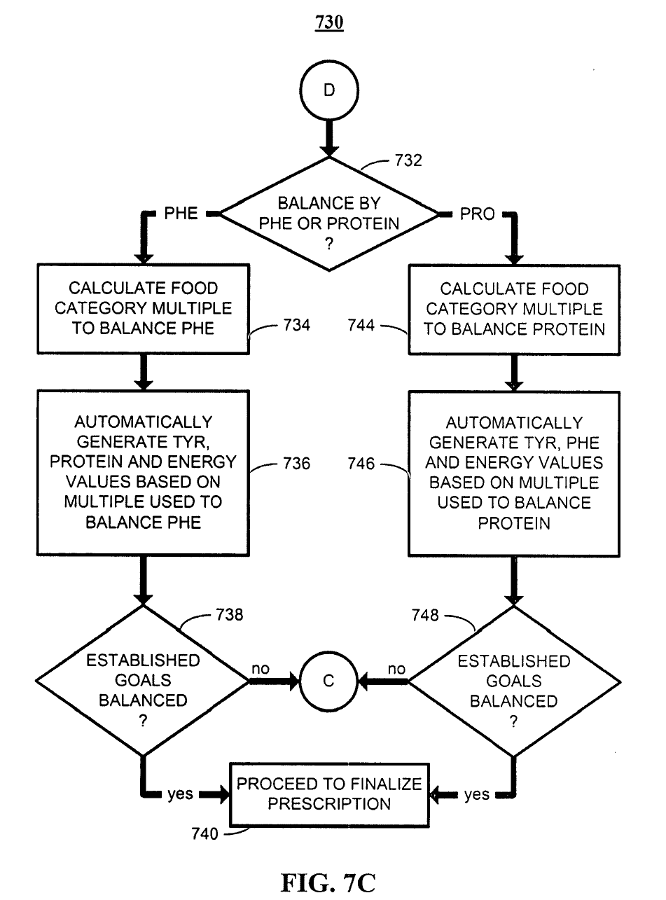

A multi-step process, as shown in conjunction with the display pages illustrated in FIGS. 4B-4H, is employed for creating new, as well as updating existing, dietary prescription plans. There are obvious modifications to the options and information that may be presented to a practitioner on the display pages of FIGS. 4B-4H dependent on whether the dietary prescription plan is new or being updated. However, for the sake of simplifying the understanding of the multi-step process, the generation of a new dietary prescription plan is described in connection with the display pages illustrated in FIGS. 4B-4H, with additional detail being provided in connection with the processes flow diagrams illustrated in FIGS. 6A-6C and 7A-7C.

Creation of a new dietary prescription plan is initiated from a patient designation display page 410 illustrated in FIG. 4B, wherein practitioners are provided with a listing of their patients under a patient database designation 412. Upon selection of a patient from the listing, a patient history option 414 is made available for viewing the selected patient's history, if such information is available. Patient history option 414, when selected, may display information pertaining to a patient's attributes considered relevant to calculation of nutritional goals, previous dietary prescription plans, effectiveness of previous dietary prescription plans in meeting established nutritional goals and any other information that may be considered relevant to constructing an appropriate dietary plan. Once a patient has been selected from patient database 412 and their corresponding history reviewed, practitioners may proceed to the next step in creating the dietary prescription plan by selecting, for example, a next step option 416 provided at the bottom of display page 410.

Option 416, when selected, takes practitioners to a nutritional goals display page 420, as illustrated in FIG. 4C. Display page 420 provides practitioners with a breakdown of relevant patient attributes, as illustrated under profile 422, and suggested dietary prescription goals, as illustrated under profile 424. The patient attributes identified under profile 422 are utilized in computing the required nutritional goals identified under profile 424. Therefore, upon selection of a patient from the patient listing provided under patient database designation 412, practitioners are provided with an opportunity to adjust and update the relevant attributes identified under profile 422, thereby allowing the patient management system to retrieve the most up-to-date patient information for calculating the average daily allowances of nutritional goals identified under profile 424. The system may be configured so that attributes defined under profile 422, once updated and retrieved by the system, are referenced against a predefined recommended nutritional intake table, as well as prior attributes and nutritional goal values stored in a patient's history profile, to derive at the nutritional intake values defined under profile 424. Alternatively, a recommended intake table option 425 may be provided for reference by practitioners, allowing them to determine whether they wish to manually adjust pre-calculated values provided under profile 424.

Once the nutritional intake values are derived, a goals profile 426 is generated. Goals profile 426 may be provided to summarize the nutritional goal values calculated by the system under profile 424, associating the values accordingly with an established goals field 427a. As a practitioner progresses through the creation of the dietary prescription plan, the actual nutritional values that have been filled are updated in field 427b. The practitioner's ultimate goal is to create a dietary prescription plan that results in a match between filled nutritional values in field 427b with established nutritional goal values in field 427a. A matched check box 427c may be presented when established nutritional goal values in field 427a have been met and, similarly, a non-matched check box 427d may be presented when established nutritional goal values in field 427a have yet to be met, to assist practitioners in verifying if the current dietary prescription plan being created, or previously stored in a patient database, matches established nutritional goals. As practitioners progress through the process of generating the dietary prescription plan, the nutritional values identified in field 427h should adjust accordingly.

After the average daily allowances of dietary nutritional goals have been calculated and field 426 populated with the established goal values, practitioners may proceed to the next step in the dietary prescription plan process by selecting, for example, a next step option 428 provided at the bottom of display page 420. Option 428, when selected, will present practitioners with an exchange based mechanism display page 430, as illustrated in FIG. 4D. Display 430 provides practitioners with a breakdown of select food exchanges 432, identifying dietary nutritional values associated with each of food exchange categories 432a. Food exchange categories 432a may include, for example, breads/cereals, fats, fruits and vegetables. Unit value fields 432b are provided for adjusting nutritional values associated with each of food exchange categories 432a. Initially, the values provided in unit value fields 432b may be automatically adjusted by the system in trying to balance nutritional values in field 427b with the pre-calculated dietary nutritional goal values established in field 427a. Alternatively, practitioners may be provided with an option for overriding the automated determination of values in fields 432b, allowing practitioners to increase or decrease intake of a particular food exchange category 432a over another. The steps employed in the food exchange mechanism are further described in connection with the flowcharts of FIGS. 6A-6C.

Once food exchange unit values have been selected, practitioners may proceed to the next step in the dietary prescription plan process by selecting, for example, a next step option 434 provided at the bottom of display page 430. Option 434, when selected, takes practitioners to a medical foods mixture display page 450, as illustrated in FIG. 4E. Various medical food mixture options are provided on display page 450 to supplement any deficiency in the established dietary nutritional goal values that have not been satisfied by the unique combination of exchange unit values determined in the food exchange mechanism of FIG. 4D. A medical foods mixture profile 452 may be provided, having a plurality of pull-down menus containing various medical food mixture selections 452a. Medical food mixture selections 452a may include, for example, all major branded products for providing flexibility in choices. The system is configured so that medical food mixture measurements 452b are automatically calculated once a combination of mixture selections 452a are selected. A lock/unlock feature 452c may be provided to disable the auto-calculation of mixture measurements 452b, thereby again allowing practitioners to force the desired value of one product over another and add variety and customization to dietary prescription plans for their patients.

After completing a proposed dietary prescription plan, practitioners may save the plan as a draft for later review, using option 454. Alternatively, practitioners may proceed through the remainder of the dietary prescription plan process by selecting, for example, a next step option 456 provided at the bottom of display page 450. Option 456, when selected, takes practitioners to a review and comment display page 460, as illustrated in FIG. 4F. Here practitioners may review and verify the proposed dietary prescription plan generated for their metabolic patient and, if satisfied with the values presented in field 462b with respect to the values in established goals field 462a, both of which may be provided under a final summary of nutritional goals profile 462, they may proceed to the finalizing stage of the dietary prescription plan process by selecting, for example, a next step option 466 provided at the bottom of display page 460. Display 460 also provides practitioners with a comments field 464 for entering comments and notes relating to the dietary prescription plan created on behalf of their metabolic patient.

Option 466, when selected, takes practitioners to a review and finalize display page 470, as illustrated in FIG. 4G. Display page 470 may provide practitioners with a complete prescription and corresponding nutrient breakdown summary 472 of the dietary prescription plan created. For example, a prescription tab 472a may be provided to display a complete breakdown of the dietary prescription plan, including food exchange calculations, medical food mixtures, energy fillers, comments related to the dietary plan and established goals that are further broken down, for example, into nutrient values consumed per day and per kg. Similarly, a nutrients tab 472b may be provided to display similar relevant values and features such as, for example, a breakdown of an amino acid profile, minerals and vitamins consumed in connection with the dietary prescription plan created.

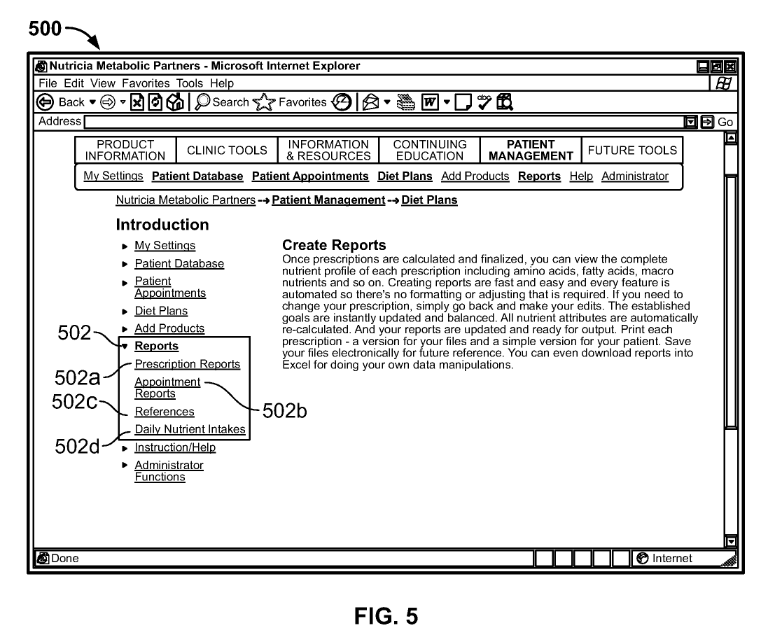

The foregoing dietary prescription plan summarized on display page 470 may then be finalized by selecting, for example, a finalize option 474 at the bottom of display page 470, thereby taking practitioners to a finalized prescription display page 480, as illustrated in FIG. 4H. Display page 480 provides a printable copy 482 of the dietary prescription plan for patients, as well as for internal practitioner records. In another embodiment of the present invention, practitioners may also be provided with options for creating various reports related to a dietary prescription plan that has been finalized and saved in a practitioner's corresponding patient database. A create reports display page 500 is shown in FIG. 5, wherein a reports menu 502 is provided. Reports menu 502 may provide practitioners, for example, with a prescription reports option 502a, an appointment reports option 502b, a references reports option 502c and a daily nutrient intakes reports option 502d. The foregoing options allow a practitioner to generate reports for various applications.

The primary steps employed in creating a dietary prescription plan are further illustrated in connection with the process flowcharts of FIGS. 6A-6C and 7A-7C. In FIG. 6A, a practitioner initiates process flow 600 for generating a dietary prescription plan by submitting login information via, for example, user access device 102 (FIG. 1). The system prompts and receives the practitioner's login information, at step 602, and determines, at step 604, if the practitioner is a registered and authorized user of the secure patient management system. Access to the patient management system is provided, at step 606, upon verification of the practitioner, at step 604.

Once logged in to the system, practitioners may direct their patient management activities to any particular metabolic patient having a record stored in their corresponding database of patients, which may stored on and retrieved from, for example, databases 116, 118 or 120 (FIG. 1). Upon receiving a user selection and retrieving, at step 608, the patient record from the appropriate database, patient details including their corresponding attributes are displayed to the practitioner, for example, on web browser 110 accessible via user access device 110 or wireless user access device 112. A metabolic patient's details and attributes may be updated by the practitioner and received, at step 610, by any of databases 116, 118 or 120 via communication network 100 for secure storage and accessibility. Various attributes pertaining to a metabolic patient may be updated, at step 610, in order to allow for accurate determination of nutritional deficiencies and calculation of corresponding appropriate dietary prescription plans. For example, as previously described, a practitioner may provide updates with respect to a metabolic patient's weight, height, disorder(s), PHE level, TYR level, protein level, energy level or any combination thereof.

Once a patient is selected from a secure database, and their corresponding attributes updated to reflect the patient's most current metabolic disorder, an accurate dietary prescription plan may then be created for the patient. The actual creation of a dietary prescription plan is initiated at step 612 and provides practitioners with an option for using previously defined nutritional goals in an existing prescription plan or creating a new prescription plan having a new set of nutritional goals. If a practitioner selects to use an existing dietary prescription plan, the system initiates process flow 620 illustrated in FIG. 6B and loads, at step 622, a history listing of previously created and saved prescriptions for the metabolic patient selected. A determination is then made, at step 624, to confirm whether the practitioner has elected to proceed with copying goals set out in a previous dietary prescription plan. If copying of goals in the previous dietary prescription plan are confirmed, the nutritional goals associated with that plan are loaded, at step 626, into the current dietary prescription plan being created. Thereafter, the system may proceed, at step 628, to another process for assisting the practitioner to fill and finalize the dietary prescription plan. The mechanism implemented for filling prescriptions is further described in conjunction with the process flowcharts illustrated in FIGS. 7A-7C. If the practitioner decides, however, not to utilize goals set out in a previously stored prescription in order to calculate and establish a new set of nutritional goals (e.g., when existing goals are no longer best serving the metabolic health of a patient), process flow 620 is further configured to determine, at step 630, whether the practitioner has instead elected to create a new prescription.

When a practitioner elects to create a new dietary prescription plan to incorporate a new set of nutritional goals, process flow 640 of FIG. 6C is initiated. Process flow 640 is configured to automatically compute, at step 642, average daily allowances of PHE, TYR, protein and energy based on pre-defined metabolic disorder tables having recommended nutrient intakes and corresponding patient attributes. The computation values yielded, at step 642, are then loaded, at step 644, as the new established nutritional goals in the dietary prescription plan. Thereafter, the system may proceed, at step 646, to the mechanism for assisting the practitioner to fill the current dietary prescription plan.

In FIG. 7A, a process flow 700 is provided to illustrate the steps employed for filling dietary prescription plans in accordance with the pre-calculated established nutritional goals. Process flow 700 executes instructions for retrieving and loading, at step 702, the mechanism for filling a prescription, which may prompt practitioners to select between an exchange or non-exchange based mechanism for filling the prescription. Whether or not an exchange based mechanism has been elected by the practitioner is determined at step 704.

A dietary prescription plan that is filled utilizing the exchange based mechanism consists of predefined food exchange categories comprising breads/cereals, fats, fruits and vegetables. Each of these food exchange categories, as illustrated in FIGS. 4D and 4E, have corresponding predefined unit values of PHE, TYR, protein and energy, which are adjusted accordingly using an exchange unit multiple value assigned to each food exchange category. To best meet the established nutritional goal values of PHE, TYR, protein and energy that have been calculated for a particular patient, the exchange unit multiple value for each of the food exchange categories may be determined and adjusted automatically by the patient management system. Thus, by designating an appropriate multiple number value in each of unit value fields 432b, as illustrated in FIGS. 4D and 4E, each food exchange category is best balanced in accordance with the nutrient goals established by calculations implemented in process now 620 or 640. The PHE exchange value is calculated first, at step 706. Once PHE is balanced or brought to a value as close as possible to the established nutritional goal value, protein must then be balanced. The protein exchange value is calculated, at step 708. Thereafter, TYR and energy exchange values are calculated, at step 710, and balanced as best as possible in accordance with the established nutritional goals and calculations performed at steps 706 and 708.

Once calculations for balancing PHE, protein, TYR and energy are completed, checks are made, at steps 712 and 714, to determine if exchange based balancing requirements of established nutritional goals have been met. More specifically, a check is made, at step 712, to determine if PHE and protein have been properly balanced by the calculations preformed at steps 706 and 708. Process flow 700 is configured to recognize that PHE and protein must be properly balanced to fill and finalize a dietary prescription plan. If PHE and protein are not properly balanced against established goals, the practitioner is directed to a process 720, as detailed FIG. 7B, for supplementing the exchange based calculations, regardless of whether or not TYR and energy have been balanced. However, if PHE and protein are determined to be balanced, then process 700 proceeds to determine, at step 714, whether TYR and energy have been balanced. TYR and energy are not required to be balanced in order to fill and finalize a dietary prescription plan. If TYR and energy are balanced, process 700 proceeds to finalize the dietary prescription plan, at step 716. However, if TYR and energy are not balanced, a practitioner may optionally elect, at step 718, whether to finalize the dietary prescription plan or proceed to process 720 for supplementing the exchange based calculations with a medical food mixture, in order to attempt to further balance TYR and energy nutrient values.

Various combinations of medical food mixtures may be created by a practitioner, as originally described in connection with display page 450 of FIG. 4E. As illustrated in display page 450, medical food mixtures may be comprised of various categories and menus such as, but not limited to, a “PHE Sources” menu, a “Medical Foods” menu, a “Supplements” menu and an “Other Medical Foods” menu. In a preferred embodiment, the “PHE Sources” menu would be used to select a preferred PHE product for balancing deficiencies in PHE values, wherein after PHE values are balanced with the established nutritional goal values, the aforementioned remaining menus may then be enabled by the patient management system to allow for balancing of existing deficiencies, if any, in TYR, protein and energy values.

Multiple “Medical Foods” menus may be provided, allowing practitioners to select more than one product to be used for balancing a deficiency in protein. For example, if two products are selected from multiple “Medical Foods” menus, process 720 is configured to balance protein deficiencies between the two selected products. The “Supplements” menu may contain L-Tyrosine to balance TYR deficiencies. The “Other Medical Foods” menu may provide an additional listing of suitable protein products. If protein is still unbalanced, this menu may be used to balance the remaining protein deficiency. Additionally, energy filler options may be provided in the medical food mixtures display page illustrated in FIG. 4E. For example, an “Other Energy Sources” menu and “Free Food” menu may be provided in order to allow for balancing of energy deficiencies in a dietary prescription plan. It should be noted that other menu types may be incorporated to allow for various medical food mixtures to be constructed, and the preceding description of medical food mixture menus is provided merely as an example for illustrating the nutrient balancing process of the present invention.

In another embodiment, process flow 720 may also be configured to recommend medical food mixtures to the practitioner based on the degree of deficiency in nutrients, as well as the attributes of a particular metabolic patient and his or her disorder type. In yet another embodiment, practitioners may be permitted to add their own dietary products to the foregoing menus to provide for more diversity in dietary product selections that can be offered to their patients. For example, practitioners wanting to add and manage their own dietary products may select products management option 208 (FIG. 2), which may present display pages (not shown) for soliciting information pertaining to the product to be added. Information pertaining to, for example, the name of their product, a category selection (e.g., “Medical Foods”) for associating the product, age range applicability of the product, PHE value, TYR value, protein value, energy value and the product measurement associated with the aforementioned nutrient values inputted may be collected by the patient management system.

Upon receiving, at step 722, selections associated with the desired medical food mixture, the system is configured to determine, at step 724, the deficiencies in PHE and protein and to calculate, at step 726, the required measurements of each product in the medical food mixture selected by the practitioner to satisfy those deficiencies. Once PHE is balanced, the remaining medical food mixture selections are enabled and deficiencies are calculated, at step 728, for TYR and energy in accordance with the product selections made in corresponding means. Once all the nutrients have been balanced accordingly, the system proceeds to finalize, at step 730, the dietary prescription plan.

In a non-exchange based method, balancing of PHE and protein with respect to the patient's established nutritional goal values is even further simplified. In this particular embodiment, if selected, a practitioner may balance established nutritional goals either by PHE or by protein. Based on the selection made, either PHE or protein will control the calculation and the remaining nutritional goals that have been established are automatically generated based on the multiple value used to meet either PHE or protein nutritional goals. A process flow 730 is illustrated, in FIG. 7C, to depict the steps employed for filling a dietary prescription plan when a non-exchange based mechanism is selected.

In a non-exchange based mechanism, the patient management system begins by first determining, at step 732, whether a practitioner has elected to balance established nutritional goals by PHE or protein. For purposes of illustrating the functionality of the non-exchange process we will assume, for example, that the unit breakdown for the non-exchange process is 50 mg for PHE, 40 mg for TYR, 1 g for protein and 120 kcal for energy and that a patient's established nutritional goals requires 200 mg PHE and 4 g protein. If the practitioner selects to balance by PHE, the appropriate multiple of the aforementioned unit value for PHE is determined, at step 734, that best satisfies, without exceeding, the established nutritional goal value for PHE. Using the unit and established nutritional goal values provided, the unit PHE value of 50 mg is increased by a multiple of 4 in order to satisfy the established nutritional PHE goal value of 200 mg.

Since PHE controls in this calculation, the multiple of 4 is applied against the remaining unit values of 40 mg for TYR, 1 g for protein and 120 kcal. Therefore, at step 736, the foregoing unit values for TYR, protein and energy are increased by a multiple of 4, generating values of 160 mg TYR, 4 g protein and 480 kcal of energy. Unlike the previously described exchange based mechanism, here food categories are automatically filled in accordance with these multiple values, all of which are linked to a balanced PHE goal value. If the remaining multiple values for TYR, protein and energy are determined, at step 738, to also satisfy their corresponding established nutritional goal values, then the system proceeds to finalize the prescription, at step 740. However, if the remaining multiple values do not meet their corresponding established nutritional goal values, particularly the established protein value, then the system is configured to proceed to process 720, as previously described in connection with FIG. 7B, for supplementing the deficiencies in nutritional goals with a medical food mixture.

Calculations in connection with the non-exchange mechanism utilizing protein are the same. Here if the practitioner selects to balance by protein, the appropriate multiple of the aforementioned unit value for protein is determined, at step 744, that best satisfies, without exceeding, the established nutritional goal value for protein. Using the aforementioned unit and established nutritional goal values, the unit protein value of 1 g would need to be increased by a multiple of 4 in order to satisfy the established nutritional protein goal value of 4 g.

Since protein controls in this calculation, the multiple of 4 is applied against the remaining unit values of 50 mg for PHE, 40 mg for TYR and 120 kcal. Therefore, at step 746, the foregoing unit values for PHE, TYR and energy are increased by a multiple of 4, generating values of 200 mg PHE, 160 mg TYR and 480 kcal of energy. Here food categories are automatically filled in accordance with these multiple values, all of which are linked to a balanced protein goal. Similarly, as previously described in connection with the PHE elected non-exchange method, if the remaining multiple values of PHE, TYR and energy are determined, at step 748, to also satisfy their corresponding established nutritional goal values, then the system proceeds to finalize the prescription, at step 740. However, if the remaining multiple values do not meet their established nutritional goal values, particularly the established PHE value in this case, then the system is configured to proceed to process 720, as previously described in connection with FIG. 7B, for supplementing the deficiencies in nutritional goals with a medical food mixture.

The processes described herein drastically reduce the time of prescription creation by dynamically calculating multiple parameters and conditions based on a metabolic patient's disorder, age, weight and gender. The exchange based mechanism described herein simplifies food breakdown and their corresponding nutrient values, while medical food mixtures help balance deficiencies in the prescription, resulting in a well formed and stable dietary prescription plan for metabolic patients to follow.

The foregoing is merely illustrative of the principles of the present invention and various modifications can be made by those skilled in the art without departing from the spirit and scope of the invention described herein. Therefore, one skilled in the art will appreciate that the present invention can be practiced by other than the described embodiments, which are presented herein for purposes of illustration and not by way of limitation, and the present invention is limited only by the claims that follow.

What is claimed is:

1. A method for constructing a dietary prescription plan for an individual having a metabolic disorder, said method comprising the steps of:
receiving pre-determined attributes corresponding to said individual and said individual's metabolic disorder;
automatically calculating nutritional goal values, wherein said calculated values are determined by referencing at least one source having recommended nutrient intakes in conjunction with said received pre-determined attributes;
identifying at least one nutritional deficiency based on said calculated nutritional goal values; and
generating said dietary prescription plan, said plan identifying at least one nutrient-rich source for balancing said at least one nutritional deficiency with said calculated nutritional goal values.

2. The method of claim 1, wherein said step of receiving said pre-determined attributes includes receiving identification of said metabolic disorder.

3. The method of claim 1, wherein said step of receiving said pre-determined attributes includes receiving a measurement value for current phenylalanine (PHE) levels in said individual having said metabolic disorder.

4. The method of claim 1, wherein said step of receiving said pre-determined attributes includes receiving a measurement value for current tyrosine (TYR) levels in said individual having said metabolic disorder.

5. The method of claim 1, wherein said step of receiving said pre-determined attributes includes receiving a measurement value for current protein levels in said individual having said metabolic disorder.

6. The method of claim 1, wherein said step of receiving said pre-determined attributes includes receiving a measurement value of a current body weight of said individual having said metabolic disorder.

7. The method of claim 1, further comprising the step of implementing an exchange based mechanism having a plurality of food exchange categories, wherein a unit value is automatically determined for each of said plurality of food exchange categories to balance said at least one nutritional deficiency with a corresponding established nutritional value determined from said calculated nutritional goal values.

8. The method of claim 7, wherein said plurality of food categories is selected from the group consisting of breads and cereals, fats, fruits and vegetables.

9. The method of claim 7, wherein said unit value is automatically determined for each of said plurality of food categories to first balance a deficiency in a phenylalanine (PHE) nutrient level pre-determined in said individual having said metabolic disorder, wherein said corresponding established nutritional value is an established PHE value, and wherein said established PHE value is one of said values determined from said calculated nutritional goal values.

10. The method of claim 9, wherein said unit value is automatically determined for each of said plurality of food categories to balance a deficiency in a protein nutrient level pre-determined in said individual having said metabolic disorder, wherein said corresponding established nutritional value is an established protein value, and wherein said established protein value is one of said values determined from said calculated nutritional goal values.

11. The method of claim 10, wherein said unit value is automatically determined for each of said plurality of food categories to balance a deficiency in a tyrosine (TYR) nutrient level pre-determined in said individual having said metabolic disorder, wherein said corresponding established nutritional value is an established TYR value, and wherein said established TYR value is one of said values determined from said calculated nutritional goal values.

12. The method of claim 7, further comprising the step of providing a medical food mixture selection, wherein said mixture selection is suited for supplementing said exchange based mechanism when said mechanism is unable to independently balance said at least one nutritional deficiency with said corresponding established nutritional value determined from said calculated nutritional goal values.

13. The method of claim 12, wherein said medical food mixture selection is comprised of a plurality of medical foods and supplements made suitable for balancing deficiencies in a phenylalanine (PHE) nutrient level, a protein nutrient level, a tyrosine (TYR) nutrient level, an energy-related nutrient level or a combination thereof.

14. A system for constructing a dietary prescription plan for an individual having a metabolic disorder, comprising:
means for receiving pre-determined attributes corresponding to said individual and said individual's metabolic disorder;
means for automatically calculating nutritional goal values, wherein said calculated values are determined by referencing at least one source having recommended nutrient intakes in conjunction with said received pre-determined attributes;
means for identifying at least one nutritional deficiency based on said calculated nutritional goal values; and
means for generating said dietary prescription plan: said plan identifying at least one nutrient-rich source for balancing said at least one nutritional deficiency with said calculated nutritional goal values.

15. Machine-readable media for use in a system for constructing a dietary prescription plan for an individual having a metabolic disorder, wherein the media is encoded with machine-readable instructions for performing a method comprising:
receiving pre-determined attributes corresponding to said individual and said individual's metabolic disorder;
automatically calculating nutritional goal values, wherein said calculated values are determined by referencing at least one source having recommended nutrient intakes in conjunction with said received pre-determined attributes;
identifying at least one nutritional deficiency based on said calculated nutritional goal values; and
generating said dietary prescription plan, said plan identifying at least one nutrient-rich source for balancing said at least one nutritional deficiency with said calculated nutritional goal values.
